(19) United States
(12) Patent Application Publication
(10) Pub. No.: US 2026/0215617 A1
(43) Pub. Date: Jul. 30, 2026

(54) KITCHEN APPLIANCE

(71) Applicant: Miele & Cie. KG, Gütersloh (DE)

(72) Inventors: Stefan HINRICHS, Minden (DE); René-Pascal BRINKMANN, Bielefeld (DE); Tino BERGMEIER, Kirchlengern (DE); Michael BIEMELT, Rietberg (DE); Christian BUSSE, Rödinghausen (DE); Mario THIEL, Kirchlengern (DE); Klaus WANK, Kirchlengern (DE); Andre PETERS, Herford (DE); Ulrike LENZEN, Herford (DE); Thomas METZ, Bünde (DE); Tim Otis DIESTELHORST, Bünde (DE)

(21) Appl. No.: 19/143,002

(22) PCT Filed: Jan. 10, 2024
(86) PCT No.: PCT/EP2024/050487

§ 371 Date: Jun. 25, 2025

(30) Foreign Application Priority Data
Jan. 24, 2023 (BE) BE2023/5040

(51) Int. Cl. A47J 36/02; A47J 27/04; F24C 15/00; F24C 15/32; F24C 15/34

(52) U.S. Cl. CPC A47J 36/02; A47J 27/04; F24C 15/006; F24C 15/327; F24C 15/34; A47J 2027/043

(57) ABSTRACT

A kitchen appliance includes: an interior space for receiving at least one cookware item and/or an at least one food item through an access opening; a closure element for to closing and clearing the access opening to the interior space by pivoting a pivoting element; and at least one contact element to be contacted by a hand of a user at at least one contact surface, the at least one contact surface closing and/or opening the closure element. The at least one contact element is thermally insulated from the closure element.

### CROSS-REFERENCE TO PRIOR APPLICATIONS

This application is a U.S. National Phase application under 35 U.S.C. § 371 of International Application No. PCT/EP2024/050487, filed on Jan. 10, 2024, and claims benefit to Belgian Patent Application No. BE 2023/5040, filed on Jan. 24, 2023. The International Application was published in German on Aug. 2, 2024 as WO/2024/156509 under PCT Article 21(2).

### FIELD

The invention relates to a kitchen appliance.

### BACKGROUND

Various kitchen appliances, which can also be referred to as cooking appliances, are known for the preparation of foodstuffs, which can also be referred to as food to be treated or food to be cooked. These include cooktops on which the item to be cooked can be prepared in a cookware item, for example, in a pot with or without a lid, in a pan, or the like, by cooking, roasting, and the like.

Household appliances for the preparation of foodstuffs are known, for example, from patent publications US 2019 374 060 A1, US 2005 034 716 A1, and CN 100 549 532 C.

Further, there are known cooking appliances which have a cooking chamber that is configured in immovable (i.e., stationary) relationship with the cooking appliance and in which the item to be cooked can be placed in or on a cookware item and cooked while the cooking chamber of the cooking appliance is closed. A cooking appliance of this type can be, for example, an oven, a steam cooker, a microwave, a combination appliance composed of an oven with a steam cooker or with a microwave, and the like. At least in Germany, such cooking appliances with a stationary cooking chamber typically have an overall height (in the vertical direction) of about 45 cm, but ovens with an overall height of about 60 cm are also common.

Such cooking appliances with a stationary cooking chamber have in common that they have an outer housing as an outer enclosure that substantially encloses the cooking appliance outwardly, protecting the individual components and elements thereof and allowing them to be handled together. Formed within the cooking appliance is an interior space which constitutes the cooking chamber and is substantially enclosed by an inner housing as an inner enclosure, also referred to as the cooking chamber shell or oven shell. Between the inner enclosure and the outer enclosure, a housing space is formed as an interstitial space in which may be disposed functional elements of the cooking appliance, such as a controller or control unit, an electrical power supply, and other components that serve the intended use of the cooking appliance. As viewed in the depth direction from the front, i.e. from the perspective of a user, the outer enclosure or a front panel in the form of a furniture material or in the form of a control panel and the like, together with the inner enclosure, encloses the housing space so that the housing space is not accessible to the user.

As viewed in the depth direction, the interior space of the cooking appliance has a front-facing through-opening as an access opening through which the interior space of the cooking appliance is accessible to the user, allowing the user to insert and position cookware items in the interior space of the cooking appliance as its cooking chamber and to take out and remove cookware items from the interior space of the cooking appliance after the treatment of the item to be cooked is complete. The user can open the access opening by means of a closure element, for example, in the form of a side-swinging door, a drop-down door, and the like, in order to gain access to the interior space of the cooking appliance as previously described, or to close the interior space of the cooking appliance and perform the cooking operation or process. Such a closure element may be of a closed design or may have a viewing window to allow the user to look into the closed interior space of the cooking appliance.

Such cooking appliances with a stationary cooking chamber are typically designed as built-in appliances or built-in kitchen appliances to be fixedly disposed in a space-saving manner with their outer enclosure in kitchen furniture, such as built-in kitchen cabinets, at a vertical height that is easily accessible to the user and such that their closure element and, if present, also their front panel (see above) is/are flush with the surfaces of the other cooking appliances, drawers, doors, and the like, of the kitchen furniture, as viewed looking toward the user, which can improve the visual appearance to the user.

Also known are other built-in kitchen appliances, such as those with warming drawers, vacuum sealing drawers and the like, which are installed in the kitchen as described hereinbefore and, in particular, combined with the above-described cooking appliances as built-in appliances and arranged horizontally above one another and/or vertically adjacent to one another. Warming drawers are used, for example, to keep the cooked food warm without further cooking and to preheat dishes. In vacuum sealing drawers, food can be sealed under vacuum in an airtight package.

Patent publication EP 3 508 792 A1 A describes a kitchen appliance of the aforementioned type which is configured as a drawer.

Such drawers as kitchen appliances are basically constructed similarly to the previously described cooking appliances with a stationary cooking chamber. However, drawers are significantly flatter, i.e. smaller in the vertical direction, and must therefore be pulled forwardly out of the kitchen furniture unit by the user toward himself/herself in order to allow access to the interior space thereof vertically from above. For this purpose, the movable part of the drawer, which can also be referred to as a pull-out box, has a pull-out box bottom, which serves to receive, for example, the cookware vertically from above and may be configured to be movable in the depth direction relative to the inner enclosure of the drawer, for example via rails arranged in the transverse direction laterally. The pull-out box bottom usually has a vertically oriented front panel in the depth direction toward the front, the front panel closing the interior space of the drawer or its access opening in the closed state.

At least in Germany, such drawers, also called built-in drawers, usually have a height of about 15 cm in the vertical direction. Drawers are usually disposed vertically below a cooking appliance with a stationary cooking chamber, for example, below an oven, below a steam cooker, and the like, or combined and vertically stacked with another drawer, but can also be built individually and independently into a kitchen furniture unit. Since, at least in Germany, the installation spaces for built-in kitchen appliances in kitchen furniture, which can also be referred to as niches, usually have a vertical height of about 60 cm, a drawer having an overall height of about 15 cm and a cooking appliance with a stationary cooking space having an overall height of about 45 cm can, in particular, be modularly combined and used as built-in appliances.

Also known are cooking appliances with a steam cooking function which are configured as built-in drawers and can be referred to as steam cooking drawers. Such steam cooking drawers usually receive at least one cooking vessel with food to be cooked in their cooking chamber, which is located on the pull-out box bottom. The cooking vessel is usually removable, typically upwardly out of the open built-in drawer. Accordingly, the access opening to the cooking chamber of steam cooking drawers is horizontal and usually rectangular and can usually be closed and opened by a pivotable lid. The pivotable lid is usually mounted at the rear edge of the steam cooking drawer such that it is pivotable upwardly.

The cooking chamber of a steam cooking drawer can be closed by a lid. The lid may be configured in particular as a glass lid, so that the user can look into the cooking compartment through a glass pane of the lid when the lid is closed.

In any case, opening of the closed lid of the steam cooking drawer can be effected using a push button feature, the lid being automatically unlocked by a button function feature and pushed open by a spring. The user can then grip behind the lid from below and open it by pivoting it up so as to be able to access the cooking chamber from above. To close the lid, the user can pivot the lid back into the horizontal and then press it closed, which may result in automatic retention of the closed lid. To this end, the lid can in any case be touched by the user at the front, i.e., at the edge facing the user, in order to be operated, i.e., to be opened and/or closed.

In any case, especially when opening the lid of a steam cooking drawer, it should be remembered that during the steam cooking process in the cooking chamber of the closed steam cooking drawer, the hot steam at 100° C. reaches the lid, thus heating it up. The hot lid therefore poses a risk of burns to the user.

In order to avoid this, or at least reduce this risk, the lid can be made thicker. For this purpose, a layer of thermal insulation material can be provided on the underside of the lid, which faces the cooking chamber. If the lid has a glass pane therein, the glass pane can be made thicker. This, however, leads to a reduction in the height of the cooking chamber, which, in the case of a steam cooking drawer, is limited anyway.

Alternatively, in the case of glass lids, a double glass pane can be used, it being possible to pass air through the interstitial space or gap thereof. However, the cyclic heating and cooling can cause water to condense on the cold inner side of the double glass pane. This can lead to contamination and deposits, so that a clear view of the food to be cooked can be affected by a film of droplets or mist. In addition, this may require an additional cleaning step for the user, which may be perceived as annoying.

The interstitial space or gap of the double glass pane of a glass lid can also be filled with argon gas to enhance the thermal insulation effect. However, this results in additional costs and requires long-term gas tightness of the interstitial space or gap of the double glass pane.

In any case, all of the above-described measures can only delay the propagation of heat to the user-facing outer surface of the closed lid, and thus increase the time it takes for the outer surface of the closed lid to heat up to the final temperature of 100° C. and thus pose a risk of burns to the user. However, this cannot be prevented in this way. For this purpose, the duration of the steam cooking process would have to be reduced, but this would limit the user's options for the use of the steam cooking drawer.

This applies similarly to other kitchen appliances with a steam cooking function and generally to other kitchen appliances with a heatable cooking chamber that can be closed by means of a closure element in the form of a side-swinging door, a vertically swinging door, or a lid.

### SUMMARY

In an embodiment, the present invention provides a kitchen appliance, comprising: an interior space configured to receive at least one cookware item and/or at least one food item through an access opening; a closure element configured to close and clear the access opening to the interior space by pivoting a pivoting element; and at least one contact element configured to be contacted by a hand of a user at at least one contact surface, the at least one contact surface being configured to close and/or open the closure element, wherein the at least one contact element is thermally insulated from the closure element.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a perspective view of a kitchen furniture unit with an inventive kitchen appliance according to a first exemplary embodiment as a steam cooking drawer, shown in the retracted position;

FIG. 2 is a view corresponding to FIG. 1, but showing the steam cooking drawer in the extended position;

FIG. 3 is a more detailed plan view of the extended steam cooking drawer of FIG. 2;

FIG. 4 is a perspective representation of a side detail view of the extended steam cooking drawer of FIG. 2;

FIG. 5 is a cross-section through the front portion of the steam cooking drawer according to the first exemplary embodiment;

FIG. 6 is a cross-section through the front portion of a steam cooking drawer according to a second exemplary embodiment;

FIG. 7 is a longitudinal section through the middle of a steam cooking drawer according to a third exemplary embodiment.

### DETAILED DESCRIPTION

In an embodiment, the present invention provides a kitchen appliance, preferably a kitchen appliance with a steam function, preferably a steam cooking drawer of type described at the outset, which can prevent, or at least reduce, the risk of burns to the user when opening and/or closing the closure element of the cooking chamber. This is preferably be accomplished by reducing the temperature of the outer surface of the closed lid during the cooking process. This is preferably implemented in a kitchen appliance configured as a drawer or built-in drawer having a lid as a closure element. An embodiment of the invention achieves this in a most simple, cost-effective, space-saving, durable, and/or visually unobtrusive and appealing manner. An embodiment of the invention provides an alternative to known kitchen appliances of this type.

Thus, the invention relates to a kitchen appliance, preferably a kitchen appliance with a steam function, preferably a steam cooking drawer having an interior space, preferably a cooking chamber, configured to receive at least one cookware item and/or at least one food item through an access opening, and having a closure element, preferably a lid, configured for closing and clearing the access opening to the interior space by being pivoted by means of a pivoting element, preferably a hinge, and further having at least one contact element configured to be contacted by the hand of a user at at least one contact surface for closing and/or opening the closure element.

The kitchen appliance is characterized in that the contact element is thermally insulated from the closure element. This can be accomplished in different ways, as will be explained in more detail below, it being possible to implement different thermal insulation options in combination with each other.

In any case, a contact surface of the contact element may be provided on the outer or top side of the closure element in order to be reached by the hand or at least one finger of the user. The contact element may be an additional element disposed at or on the closure element such that it faces the user. In order to reduce heat conduction from the closure element to the contact element or its contact surface, thermal insulation may be provided between the closure element or its outer or top surface and the contact element or its contact surface. This can allow the contact element or its contact surface to become cooler than the outer or top side of the closure element, so that the user can contact or operate the closure element for opening and closing, in particular by means of a push button feature, without burning himself/herself.

In accordance with an aspect of the invention, at least one first insulating layer is thermally insulatingly disposed between the contact surface and the closure element. An insulating layer is understood to be a layer of a thermally insulating material. This can be a particularly simple way of implementation, which can be used alone or in combination with other measures, as will be explained in more detail below.

In accordance with a further aspect of the invention, at least one cooling channel, preferably a plurality of cooling channels, are arranged between the contact surface and the closure element, preferably the first insulating layer. This can be an alternative or additional measure to keep the heat of the closure element away from the contact surface of the contact element or at least to slow down its propagation. In this case, stationary air may be used as the thermal insulation material inside the cooling channel and may be enclosed within the cooling channel. The cooling channel may also be connected in air flow communication with the surrounding environment of the contact element, so that heated air can flow from the cooling channel into the surrounding environment and thus dissipate heat. This can be further enhanced by a forced air flow, as will be described in more detail below.

In accordance with another aspect of the invention, the kitchen appliance has at least one fan configured and adapted to generate an air flow through the cooling channel. As mentioned earlier, this can increase the dissipation of heat and thus have a cooling effect on the contact element.

In accordance with a further aspect of the invention, the fan is configured as a chimney fan and adapted to be driven by means of the Seebeck effect of a thermoelectric power generator. This allows the fan to be operated without additional electrical power supply and without a controller by being able to use the temperature differential that develops during the cooking process to generate electrical energy and to use this electrical energy to operate the fan as a chimney fan.

In accordance with another aspect of the invention, at least one Peltier element is disposed between the contact surface and the closure element, preferably the first insulating layer. When electrical energy is supplied to a Peltier element, it can generate temperature differential, thus allowing the contact element or its contact surface to be actively cooled.

One aspect is that the closure element is only partially covered by the contact element, in particular the contact surface of the contact element. This not only makes it possible to visually define the area for the most advantageous introduction of force. This embodiment allows a large portion of the surface area of the closure element to remain uncovered, especially in the case of a closure element that is made of glass and intended to provide the best possible view into the interior space. Preferably, the width of the contact element, in particular of the contact surface, is less than half the width of the closure element. The width is measured parallel to the transverse direction. Preferably, the depth of the contact element, in particular of the contact surface, is less than half the depth of the closure element.

Preferably, the width of the contact element, in particular of the contact surface, is greater than 5 centimeters and/or the depth of the contact element, in particular of the contact surface, is greater than 3 centimeters. This allows the contact surface to be contacted by at least one, or a plurality of fingers.

A specific embodiment of the household appliance provides that the closure element has a transparent glass pane, with only a portion of the glass pane of the closure element being covered by the contact element, in particular by the contact surface of the contact element.

In accordance with a further aspect of the invention, the Peltier element is configured and adapted to be powered by means of the Seebeck effect of a thermoelectric power generator. Thus, in this case, too, the Peltier element can be operated without additional electrical supply and without a controller by means of the temperature differential that develops during the cooking process, as described earlier herein.

According to another aspect of the invention, the thermoelectric power generator is in thermally conductive contact both with the interior space and with an outer enclosure.

Accordingly, the temperature differential between the interior space and exterior enclosure can be used to generate electrical current to operate the fan and/or the Peltier element as described hereinbefore.

In accordance with another aspect of the invention, at least one locking element is thermally conductively disposed between the contact surface and the closure element, preferably the first insulating layer, the locking element being configured and adapted to retain the closure element in the closed state, the locking element further being configured to be in thermally conductive contact with an interstitial space and/or with an outer enclosure when the closure element is in the closed state. Thus, in addition to its retaining function, the locking element can also be used to create a thermal bridge to absorb and dissipate heat from the closure element without this heat reaching the contact element or its contact surface. This can additionally or alternatively have a cooling effect.

In accordance with a further aspect of the invention, the kitchen appliance, preferably the outer enclosure, has at least one heat sink configured to be in thermally conductive contact with the locking element when the closure element is in the closed state. This can promote the dissipation of the removed heat into the surrounding environment.

In accordance with another aspect of the invention, a thermally conductive layer is disposed between the contact surface and the closure element, preferably the first insulating layer, and adjacent to the locking element, and in thermally conductive contact with the locking element. This can promote heat conduction toward the locking element.

In accordance with a further aspect of the invention, a second insulating layer is thermally insulatingly disposed between the contact surface and the locking element as well as the thermally conductive layer. This can enable an additional thermal insulation effect.

In accordance with another aspect of the invention, the closure element has a first glass plane and a second glass plane at least in portions thereof, which first and second glass planes are spaced apart by an interstitial space. This can enable an additional thermal insulation effect.

In accordance with a further aspect of the invention, the interstitial space is filled with a thermally insulating gas, preferably with argon. This can further enhance the additional thermal insulation effect. Using argon for this purpose can be an economical and effective way of implementation.

In accordance with another aspect of the invention, the kitchen appliance is configured as a drawer. This can enable the implementation and use of the previously described features and advantages, especially with kitchen appliances of this type.

The above figures are viewed in Cartesian coordinates. A longitudinal direction X can also be referred to as depth X or length X. Perpendicular to longitudinal direction X is a transverse direction Y, which can also be referred to as width Y. A vertical direction Z, which can also be referred to as height Z and corresponds to the direction of gravity, is perpendicular to both the longitudinal direction X and the transverse direction Y.

Longitudinal direction X and transverse direction Y together define the horizontal X, Y, which can also be referred to as horizontal plane X, Y.

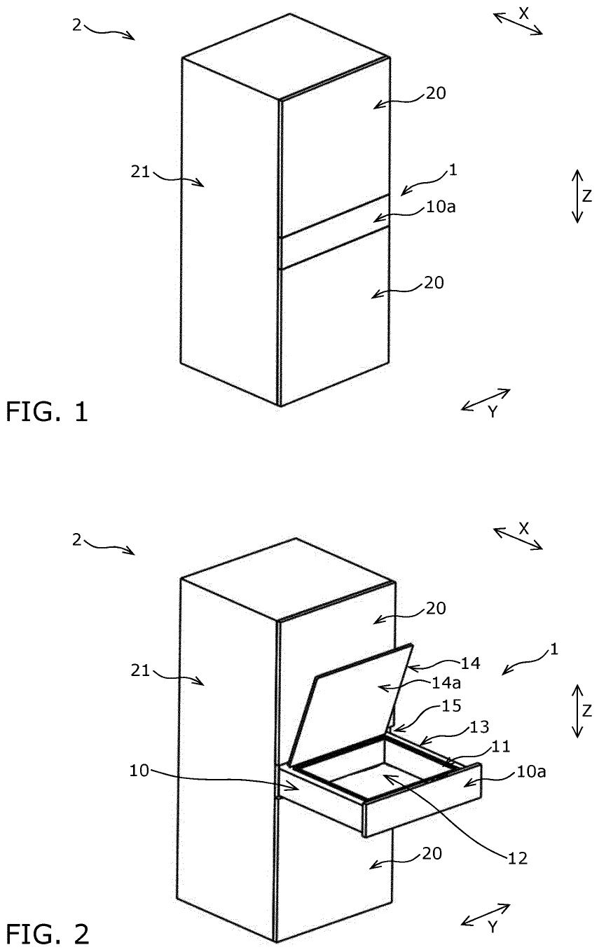

FIG. 1 illustrates, in perspective view, a kitchen furniture unit 2 with an inventive kitchen appliance 1 according to a first exemplary embodiment as a steam cooking drawer 1, shown in the retracted position. FIG. 2 represents a view corresponding to FIG. 1, but showing steam cooking drawer 1 in the extended position;

Kitchen furniture 2, which can also be referred to as kitchen cabinet run 2, has a furniture front 20 or a plurality of furniture front panels 20 facing a user and forming the front end of kitchen furniture unit 1 in longitudinal direction X. Furniture front 20 is formed by several doors, hinged panels, and the like (not labeled), and possibly drawers, which are pivotably, hingedly, or extendibly mounted on a frame 21, framework 21, or carcass 21 of kitchen furniture unit 2.

A kitchen appliance 1 according to the invention in the form of a steam cooking drawer 1 as a kitchen appliance 1 with a steam function is disposed approximately centrally along vertical direction Z between two furniture fronts 20. Steam cooking drawer 1 has an outer enclosure 10, which can also be referred to as outer housing 10 and substantially delimits or encloses steam cooking drawer 1 outwardly. Outer enclosure 10 terminates along longitudinal direction X toward the front, i.e., toward the user, with a front panel 10a, which is flush with furniture fronts 20 of kitchen furniture unit 2 when steam cooking drawer 1 is in the retracted position (see FIG. 1). A pair of telescopic rails is mounted on outer enclosure 10 laterally in transverse direction Y, so that steam cooking drawer 1 can be extended and retracted in longitudinal direction X relative to frame 20 of the kitchen furniture unit 2.

Disposed within outer enclosure 10 is an inner enclosure 11, which can also be referred to as inner housing 11. Inner enclosure 11 terminates with outer enclosure 10 rearwardly and forwardly up to front panel 10a in longitudinal direction X, downwardly in vertical direction Z, and at both sides in transverse direction Y, so that an interstitial space is formed between outer enclosure 10 and in inner enclosure 11, which can also be referred to as housing space. This interstitial space represents the interior of steam cooking drawer 1.

Furthermore, inner enclosure 11 substantially encloses an interior space 12, in which a cooking process or a steam cooking process can be carried out. For this purpose, a steam generator is disposed in the housing space or interstitial space of steam cooking drawer 1, the steam generator being capable of evaporating water into steam and conveying the steam into interior space 12. Accordingly, interior space 12 can also be referred to as cooking chamber 12.

Interior space 12 is accessible to the user in vertical direction Z from above through an access opening 13. Access opening 13 can be closed and opened by means of a closure element 14 in the form of a lid 14. For this purpose, lid 14 is attached to outer enclosure 10 of steam cooking drawer 1 by means of at least one pivoting element 15 in the form of a hinge 15 or a lid hinge 15 such that it can be pivoted upward in vertical direction Z, so that the user can pivot lid 14 upward away from himself/herself and toward the furniture front 20 located thereabove in order to be able to access cooking chamber 12 when steam cooking drawer 1 is in the extended position, see FIG. 2. When lid 14 is pivoted down into horizontal X, Y, cooking chamber 12 is closed and steam cooking drawer 1 can be retracted into kitchen furniture unit 2, see FIG. 1.

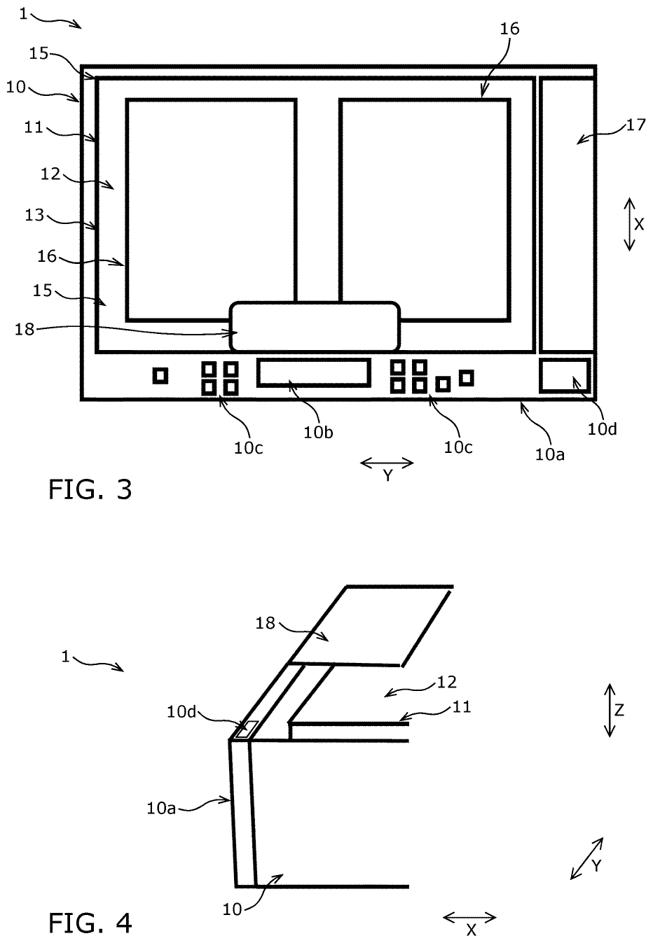

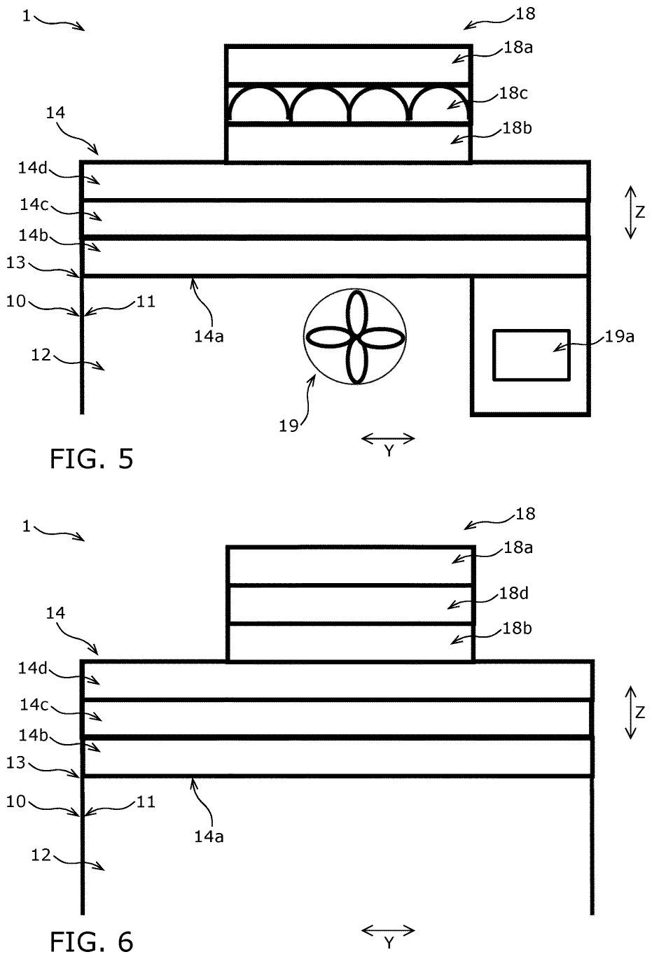

FIG. 3 shows steam cooking drawer 1 of FIG. 2 in a more detailed plan view. FIG. 4 shows, in perspective, a side detail view of the extended steam cooking drawer 1 of FIG. 2. FIG. 5 shows a cross-section through the front portion of the steam cooking drawer 1 according to the first exemplary embodiment.

As illustrated in detail in FIG. 3 (not in FIG. 2 for the sake of clarity), an indicator 10a in the form of a display 10a is disposed on top of front panel 10a so that it faces the user, and a plurality of controls 10c in the form of keys 10c are arranged adjacent thereto on both sides. An air outlet 10d is provided in the right front corner. In cooking chamber 12, two cookware items 16 as cooking containers 16 in the form of cooking dishes 16 are removably disposed side by side in transverse direction Y. A removable water reservoir 17 in the form of a water tank 17 is provided in the right area of steam cooking drawer 1.

Lid 14 is exposed to the hot steam during the steam cooking process in cooking chamber 12, so that lid 14 heats up over the duration of the steam cooking process and can reach 100° C. in accordance with the temperature of the steam. As a result, a human user can burn his/her fingers when touching the top side (not labeled) of lid 14.

In order to avoid this, lid 14, whose underside 14a or inner side 14a faces cooking chamber 12, may have a first, lower or inner glass pane 14b and a second, upper or outer glass pane 14c parallel to first glass pane 14b and spaced apart therefrom by an interstitial space 14b. Interstitial space 14b may be filled with argon to enhance the thermal insulation effect. This can reduce the heat conduction of lid 14 from its underside 14a to its top side, which faces and is accessible to the user, and thus at least increase the time it takes for the top side of lid 14 to reach a temperature that can be at least unpleasant or even dangerous for the user.

In accordance with the invention, a contact element 18, also called contact pad 18, is disposed on a portion of the top side of lid 14 centrally in transverse direction Y and toward the user or toward front panel 18a in longitudinal direction X, the top side of the contact element or contact pad facing the user as a contact surface 18a, see FIGS. 3 through 5. This allows the user to touch lid 14 at contact surface 18 a of contact pad 18 instead of at its top side, for example, to operate a push button feature of lid 14 by pressing to effect opening and closing.

In order to keep the heat of the top side of lid 14 to the extent possible away from contact surface 18a of contact pad 18, a first insulating layer 18b is thermally insulatingly disposed between contact surface 18a and the top side of lid 14.

Furthermore, a plurality of cooling channels 18c are present between contact surface 18a and first insulating layer 18b, through which air flows to convey heat away from there. For this purpose, a fan 19 is provided, which is configured and submitted to generate an air flow through cooling channel 18c. Fan 19 is configured as a chimney fan 19 and adapted to be driven by means of the Seebeck effect of a thermoelectric power generator 19a. Thus, neither an electrical supply nor a controller is needed for fan 19, as the electrical power supply for fan 19 can be obtained from the temperature differential between cooking chamber 12 and the surrounding environment. For this purpose, the thermoelectric power generator is in thermally conductive contact both with cooking chamber 12 and with an outer enclosure 10.

FIG. 6 shows a cross-section through the front portion of a steam cooking drawer 1 according to a second exemplary embodiment. In this case, a Peltier element 18d is disposed between contact surface 18a and first insulating layer 18b, which can also be electrically powered by a thermoelectric power generator 19a as described hereinbefore.

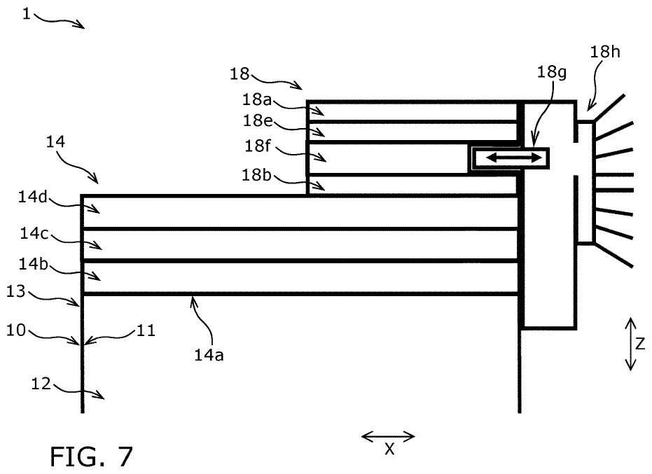

FIG. 7 is a longitudinal section through the middle of a steam cooking drawer 1 according to a third exemplary embodiment. In this case, a locking element 18g is thermally conductively disposed between contact surface 18a and first insulating layer 18b, the locking element being configured and adapted to retain lid 14 in the closed state. Locking element 18g is further configured and adapted to be in thermally conductive contact with an interstitial space and also with outer enclosure 10 when lid 14 is in the closed state. Thus, heat which reaches locking element 18g via first insulating layer 18 b can be dissipated to the outside via locking element 18g and thus kept away from contact surface 18 a of contact pad 18.

In order to enhance the release of heat to the outside, steam cooking drawer 1 has a heat sink 18h disposed outwardly at its front panel 10a or within the interstitial space, which heat sink 18h is configured to be in thermally conductive contact with locking element 18g when lid 14 is in the closed state.

For this purpose, a thermally conductive layer 18f may also be disposed between contact surface 18 a and first insulating layer 18 b and adjacent to locking element 18g, and in thermally conductive contact with locking element 18g, so that a greater amount of heat can be conducted to locking element 18g and cited via locking element 18g. For additional thermal insulation of contact surface 18a of contact pad 18, a second insulating layer 18e may be thermally insulatingly disposed between contact surface 18 a and locking element 18g as well as thermally conductive layer 18f.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

X longitudinal direction; depth; length
Y transverse direction; width
Z vertical direction; height
X, Y horizontal; horizontal plane
1 kitchen appliance; kitchen appliance with a steam function; steam cooking drawer
10 outer enclosure; outer housing
10a front panel
10b indicator; display
10c controls; keys
10d air outlet
11 inner enclosure; inner housing
12 interior space; cooking chamber
13 access opening
14 closure element; lid
14a underside or inner side of closure element 14
14b first, lower, inner glass pane of closure element 14
14c interstitial space or gap of closure element 14
14d second, upper, outer glass pane of closure element 14
15 pivoting element; hinge; lid hinge
16 cookware items; cooking containers; cooking dishes
17 water reservoir; water tank
18 contact element; contact pad
18a contact surface
18b first insulating layer
18c cooling channels
18d Peltier element
18e second insulating layer
18f thermally conductive layer
18g locking element
18h heat sink
19 fan; (chimney) fan
19a thermoelectric power generator
2 kitchen furniture unit; kitchen cabinet run
20 furniture front; furniture front panel
21 frame; framework; carcass

1. A kitchen appliance comprising:
an interior space configured to receive at least one cookware item and/or at least one food item through an access opening;
a closure element configured to close and clear the access opening to the interior space by pivoting a pivoting element; and
at least one contact element configured to be contacted by a hand of a user at at least one contact surface, the at least one contact surface being configured to close and/or open the closure element,
wherein
the at least one contact element is thermally insulated from the closure element.

2. The kitchen appliance of claim 1,
wherein at least one first insulating layer is thermally insulatingly disposed between the at least one contact surface and the closure element.

3. The kitchen appliance of claim 1,
wherein at least one cooling channel is are arranged between the at least one contact surface and the closure element.

4. The kitchen appliance of claim 3,
further comprising:
at least one fan configured to generate an air flow through the at least one cooling channel.

5. The kitchen appliance of claim 4,
wherein the fan comprises a chimney fan configured to be driven by a Seebeck effect of a thermoelectric power generator.

6. The kitchen appliance of claim 1,
wherein at least one Peltier element is disposed between the at least one contact surface and the closure element.

7. The kitchen appliance of claim 6,
wherein the at least one Peltier element is configured to be powered by Seebeck effect of a thermoelectric power generator.

8. The kitchen appliance of claim 7,
wherein the thermoelectric power generator is in thermally conductive contact with both the interior space and an outer enclosure.

9. The kitchen appliance of claim 1,
wherein at least one locking element is thermally conductively disposed between the at least one contact surface and the closure element,
wherein the at least one locking element is configured to retain the closure element in a closed state, and
wherein the at least one locking element is configured to be in thermally conductive contact with an interstitial space and/or with an outer enclosure when the closure element is in the closed state.

10. The kitchen appliance of claim 9,
further comprising:
at least one heat sink configured to be in thermally conductive contact with the at least one locking element when the closure element is in the closed state.

11. The kitchen appliance of claim 9,
wherein a thermally conductive layer is disposed between the at least one contact surface and the closure element, adjacent to the at least one locking element and is in thermally conductive contact with the at least one locking element.

12. The kitchen appliance of claim 11,
wherein a second insulating layer is thermally insulatingly disposed between the at least one contact surface and the at least one locking element and the thermally conductive layer.

13. The kitchen appliance of claim 1,
wherein the closure element comprises a first glass plane and a second glass plane at least in portions thereof, which first glass pane and second glass pane are spaced apart by an interstitial space.

14. The kitchen appliance of claim 13,
wherein the interstitial space is filled with a thermally insulating gas.

15. The kitchen appliance of claim 1,
wherein the closure element is only partially covered by the at least one contact surface of the at least one contact element.

16. The kitchen appliance of claim 1, wherein the kitchen appliance has a steam function.

17. The kitchen appliance of claim 16, wherein the kitchen appliance comprises a steam cooking drawer.

18. The kitchen appliance of claim 1, wherein the interior space comprises a cooking chamber.

19. The kitchen appliance of claim 1, wherein the closure element comprises a lid.

20. The kitchen appliance of claim 1, wherein the pivoting element comprises a hinge.
